(19) United States
(12) Patent Application Publication
(10) Pub. No.: US 2015/0149247 A1
(43) Pub. Date: May 28, 2015

(54) SYSTEM AND METHOD USING MULTI-DIMENSIONAL RATING TO DETERMINE AN ENTITY'S FUTURE COMMERCICAL VIABILITY

(71) Applicant: THE DUN & BRADSTREET CORPORATION, SHORT HILLS, NJ (US)

(72) Inventors: Alla KRAMSKAIA, Edison, NJ (US); Paul Douglas BALLEW, Madison, NJ (US); Nipa BASU, Bridgewater, NJ (US); Michael Eric DANITZ, Chatham, NJ (US); Jayesh SRIVASTAVA, Woodbridge, NJ (US); Karolina Anna KIERZKOWSKI, Linden, NJ (US); Anthony James SCRIFFIGNANO, West Caldwell, NJ (US); John Mark NICODEMO, Bethlehem, PA (US); Kathleen WACHHOLZ, Nazareth, PA (US); Robin Fry DAVIES, Macungie, PA (US); Xin YUAN, Basking Ridge, NJ (US)

(73) Assignee: THE DUN & BRADSTREET CORPORATION, SHORT HILLS, NJ (US)

(21) Appl. No.: 14/267,145

(22) Filed: May 1, 2014

Related U.S. Application Data
(60) Provisional application No. 61/818,729, filed on May 2, 2013.

(51) Int. Cl. G06Q 30/02; G06N 7/00; G06N 5/04

(52) U.S. Cl. CPC G06Q 30/0202; G06N 5/04; G06N 7/005
USPC 705/7.31

(57) ABSTRACT

A method and system for determining an entity's future commercial viability which comprises: (a) using a first predictive modeling, determining a future commercial viability of the entity, the first predictive modeling is derived by identifying patterns in data and relating to predictive attributes, thereby generating a viability score; (b) using predictive modeling to generate a relative ranking of the entity against its peer group, thereby generating a comparative viability score (i.e., portfolio comparison); (c) measuring data depth to quantify how much is known about the entity and, thus, how much confidence we have in the viability score and comparative viability score, thereby generating a data depth indicator; (d) assigning a company profile by segmentation to define and group the entity with other similar entities in terms of size, years in business, availability of complete financial statement and commercial trade history; and (e) outputting a multi-dimensional viability rating comprising the viability score, comparative viability score, data depth indicator, and company profile.

### CROSS-REFERENCED APPLICATIONS

This application claims priority to U.S. Provisional Application, Ser. No. 61/818,729, filed on May 2, 2013, which is incorporated herein in its entirety by reference thereto.

### BACKGROUND

1. Field

The present disclosure relates generally to predictive and descriptive scoring/analytics. The viability rating according to the present disclosure is a multi-dimensional rating that delivers a highly insightful and reliable assessment of an entity's future commercial activity. The predictive components predict the likelihood that a company will go out of business, become inactive, or file for bankruptcy over specific period of time, for example, the next twelve (12) months. The descriptive components provide an indication of the amount of predictive data available to make a reliable risk assessments, as well as insight into characteristics of the business, for example, the age, type and size of business.

2. Discussion of the Background Art

The uniqueness of viability rating pursuant the present disclosure is that it utilizes unable to confirm or dormant activity, referred further in this document “UTC,” as part of the dependent/target variable for the model development. This was one of the use cases we have defined for the data from evaluating activity around businesses. Businesses designated as UTC have been dormant for some specific time frame, for example, 12 months, and were found to be inactive through application of multiple business rules. These rules include, but are not limited to, having an invalid address on the business, disconnected phone or no trade activity. Previously, we used bankruptcies or known confirmed out of business to make such a determination. By using UTC attributes, the method and system of the present disclosure is able to identify much larger number of businesses that are inactive or dormant—so that there is no signal to confirm their existence. Accordingly the present disclosure, use of UTC attributes provide much earlier signals pertaining to inactivity or dormancy of a business, rather than relying on hard failure data.

The present disclosure also provides many additional advantages, which shall become apparent as described below.

### SUMMARY

A multi-dimensional viability rating includes multiple components; in this example of the present disclosure the viability rating is described as using four (4) components. The first two components are highly predictive of whether an entity will cease to exist, become dormant or become inactive over the next twelve months. The third discloses the depth of available data and the fourth provides a description of the company from a demographic perspective.

A method and system for determining an entity's future commercial viability which comprises: (a) using predictive modeling to determine the future viability of the entity, the predictive modeling is derived by identifying patterns in data, e.g., UTC data, and relating to predictive attributes, thereby generating a viability score; (b) using predictive modeling to generate a relative ranking of the entity against its peer group, thereby generating a comparative viability score; (c) measuring data depth to quantify how much is known about the entity and, thus, how much confidence we have in the viability score and comparative viability score, thereby generating a data depth indicator; (d) assigning a company profile by segmentation to define and group the entity with other similar entities based on a number of features and which are, for example, defined in terms of size, years in business, availability of complete financial statement and commercial trade history; and (e) outputting a multi-dimensional viability rating comprising the viability score, comparative viability score, data depth indicator, and company profile.

A viability score is predictive rating on a viability score scale wherein, as an example, the range is between about 1 to about 9, wherein 1 is the lowest probability of an entity going out of business or becoming inactive over a period of time compared to other businesses, and 9 is highest probability of going out of business or becoming inactive.

An exemplary comparative viability score is predictive rating on a comparative viability score scale wherein as an example the range is between about 1 to about 9, where 1 is the lowest probability of going out of business or becoming inactive over a period of time compared to other businesses within the same model segment, and 9 is the highest probability of going out of business or becoming inactive.

Exemplary data depth indicator is a descriptive rating based on a data depth indicator scale wherein, as an example, the range is between about A-M. A-G is assigned on a “report card-like” scale, where A is assigned to businesses with the highest level of predictive data selected from the group consisting of: complete business identity data like number of employees or industry, extensive commercial trading activity, comprehensive financial attributes and mixture thereof, and G is assigned to a business with the lowest level of predictive data. The predictive data is basic identity data. H-M are special categories that override the A-G rating giving users further insight when confirmation that a business has met one of a predefined set of risk conditions.

An exemplary company profile is a descriptive rating based on a company profile scale wherein, as an example, the range is between about A-Z. A might represent the largest, most established businesses and X is the smallest, youngest business.

A computer readable storage media containing executable computer program instructions which when executed cause a processing system to perform a method for determining an entity's future commercial viability, the method comprising: (a) using predictive modeling to determine the future viability of the entity, the predictive modeling is derived by identifying patterns in data and relating to predictive attributes, thereby generating a viability score; (b) using predictive modeling to generate a relative ranking of the entity against its peer group, thereby generating a comparative viability score; (c) measuring data depth to quantify how much is known about the entity and, thus, how much confidence we have in the viability score and comparative viability score, thereby generating a data depth indicator; (d) assigning a company profile by segmentation to define and group the entity with other similar entities based on a number of features and which are, for example, defined in terms of size, years in business, availability of complete financial statement and commercial trade history; and (e) outputting a multi-dimensional viability rating comprising the viability score, comparative viability score, data depth indicator, and company profile.

A computer system for determining an entity's future commercial viability, the system comprising: a processor which execute the following steps stored in memory; the steps comprising: (a) using predictive modeling to determine the future viability of the entity, the predictive modeling is derived by identifying patterns in data and relating to predictive attributes, thereby generating a viability score; (b) using predictive modeling to generate a relative ranking of the entity against its peer group, thereby generating a comparative viability score; (c) measuring data depth to quantify how much is known about the entity and, thus, how much confidence we have in the viability score and comparative viability score, thereby generating a data depth indicator; (d) assigning a company profile by segmentation to define and group the entity with other similar entities based on a number of features and which are, for example, defined in terms of size, years in business, availability of complete financial statement and commercial trade history; and (e) outputting a multi-dimensional viability rating comprising the viability score, comparative viability score, data depth indicator, and company profile.

A computer system for determining an entity's future commercial viability, the system comprising: a database comprising activity signal data; an activity signal generator which aggregates the activity signal data using a plurality of data sources from multiple of businesses that are in business with an entity of interest; and a model generator which generates a viability score based upon a statistical model in which a dependent variable performance is derived using statistical probability from independent variables created from a plurality of data sources.

The processor executes the following steps stored in memory; the steps comprising: (a) using a first predictive modeling, determining a future commercial viability of the entity, the first predictive modeling is derived by identifying patterns in data and relating to predictive attributes, thereby generating a viability score; (b) using a second predictive modeling to generate a relative ranking of the entity against its peer group, thereby generating a comparative viability score; (c) measuring data depth to quantify how much is known about the entity and how much confidence is had in the viability score and the comparative viability score, thereby generating a data depth indicator; (d) assigning a company profile by segmentation to define and group the entity with other similar entities; and (e) outputting a multi-dimensional viability rating comprising the viability score, the comparative viability score, the data depth indicator, and the company profile.

The activity signal generator comprises: a matching process which upon finding a match produces a signal; a logging process which receives the signal, and enters it into metadata; and an aggregator which aggregates data from the metadata, thereby producing the activity signal data. The signal comprises at least one signal selected from the group consisting of: (a) identification of source from which data was received; (b) a time at which the match was made; (c) unique identifier 341; and (d) a confidence code.

Further objects, features and advantages of the present disclosure will be understood by reference to the following drawings and detailed description.

### BRIEF DESCRIPTION OF THE DRAWINGS

FIG. 1A is a block diagram of a system for employment of the techniques disclosed herein;

FIG. 1B is a block diagram of a processing module of the system of FIG. 1A;

FIG. 1C is a block diagram of an activity signal generator that is a component of the processing module of FIG. 1B;

FIG. 2 is a flow diagram which describes the scoring process according to the present disclosure used in the predictive models for determining both the viability score and comparative viability score;

FIG. 3 is the depth of data table used in the present disclosure;

FIG. 4 is a company profile table used to interpret the portfolio component of the present disclosure;

FIG. 5 is a flow chart depicting how a viability score and data depth score are used to calculate a viability rating across the four model segments, i.e. financial segment, established trade payment, limited trade payment and no trade payment; and

FIG. 6 is an example of weighting scheme according to the present disclosure.

### DETAILED DESCRIPTION OF THE PREFERRED EMBODIMENT

Viability rating is a multi-dimensional rating that delivers a highly insightful and reliable assessment of a company's future viability. The viability rating includes both predictive and descriptive components. The predictive components predict the likelihood that a company will go out of business, become inactive, or file for bankruptcy over a defined period of time, for example, for example the next 12 months. The descriptive components provide an indication of the amount of predictive data available to make a reliable risk and/or a commercial activity assessment, as well as insight into the business size measurements based on a range of characteristics, for example, age, type and size of business. The exemplary components used in generating a viability rating are:
Viability score: predictive rating on a scale, for example, is in the range between about 1-9, where 1 is the lowest probability of going out of business or becoming inactive over a period of time, e.g., the next 12 months, compared to other businesses and 9 is highest probability of going out of business or becoming inactive. UTC 129 data was used as an ingredient to dependable variable in a statistical model development. UTC 129 data captures data for inactive and dormant businesses. Detailed trade data 135 predictors were very significant independent variables in model development as well.
Portfolio comparison: predictive rating on a scale, for example, in the range between about 1-9, where 1 is the lowest probability of going out of business or becoming inactive over a period of time, e.g., the next 12 months, compared to other businesses within the same model segment and 9 is the highest probability of going out of business or becoming inactive. Detailed trade data 135 was used to define model segmentation which enabled to deliver models which compare viability of businesses within same commercial activity levels, e.g., businesses that have low number of payment transactions.
Data depth indicator: descriptive rating on a scale, for example, in the range between about A-M. A-G is assigned on a “report card-like” scale, where, for example, A is assigned to businesses with the highest level of predictive data including complete business identity, extensive commercial trading activity, and comprehensive financial attributes, and G is assigned to a business with the lowest level of predictive data including basic identity data only. Categories such as H-M can be devoted to special categories that override A-G rating giving users further insight when confirmation that a business has met one of a predefined set of risk conditions. Many data sources were used to define data depth indicator. Some of the attributes derived from UTC 129, detailed trade data 135 and business reference data 140 were significant contributors in creation of viability rating component, data depth indicator.
Company profile: descriptive rating on a scale, for example, in a range between about A-Z, where A is the largest, most established businesses Z is the smallest, youngest business. An exemplary company profile was defined using multiple data sources which include detailed trade data 135, e.g., number of payment transactions, and business reference data 140, e.g., number of years in business.

A viability rating uses statistical probabilities to classify business into, e.g., a 1-9 risk rating segmentation. These classifications are based on the chance that a company, for example, will go out of business, become inactive or dormant, or file for bankruptcy over a period of time, e.g., the next 12-months.

A data depth indicator uses a point system to assign a numeric value to a data attribute based on its ability to enhance the predictive accuracy of a viability rating. The more predictive a data attribute, the more points assigned. For example, financial data and extensive trade data may have higher predictive index, enabling robust prediction. So they receive higher points, placing a company higher on the A-M scale.

A company profile uses segmentation to define and group businesses that are similar in terms of, for example, their size (e.g., employees and annual sales), and their age (e.g., years in business).

A viability rating utilizes the combined power of extensive data on a business including, but not limited to, business activity signals, detailed commercial transactional payment experiences derived from accounts receivables invoice level data.

A viability rating uses statistical model building techniques including, but not limited to, segmentation analysis and subsequent regression analysis.

Exemplary viability score and portfolio comparison use statistical probabilities to classify businesses into risk rating ranging as an example between 1 and 9 where 1 shows the lowest probability of becoming inactive and 9 is the highest probability of becoming inactive. These classifications are based on the chance that a company will go out of business, become inactive or dormant, or file for bankruptcy over the next 12-months.

These statistical probabilities were developed using a statistical model development approach, a regression where the probability of an outcome, like going out of business or becoming dormant in the next 12 months, is observed through modeling of independent variables, predictors that capture this behavior.

Data depth indicator uses a point system to assign a numeric value to a data attribute based on its ability to enhance the predictive accuracy of a viability score and portfolio comparison. The more predictive a data attribute, the more points assigned. For example, financial data and extensive transactional payment information data have higher predictive index, enabling robust prediction. So they receive higher points, placing a company higher on exemplary A-M scale.

Exemplary company profile uses segmentation to define and group businesses that are similar in terms of their size (employees and annual sales), their age (years in business) and the availability of complete financial statements and commercial trade history.

Viability rating utilize multiple data sources like business activity signals data (ASD) 160, detailed commercial payment experiences that capture month-to-month trends referred in this document as detailed trade 135 derived from the accounts receivable transactional payment data, UTC 129, and business reference data 140.

Viability rating, as an example, predicts a business's likelihood of:
Voluntarily or involuntarily going out of business
Becoming dormant or inactive
Filing for bankruptcy

The underlying models for a viability rating are based upon the observed characteristics of hundreds of thousands of businesses and the relationship these characteristics have to the probability of meeting the above definition.

A score, e.g., in the range between about 1-9, is assigned by the model. This is a segmentation of the scorable universe into nine distinct risk groups where a one (1) represents businesses that have the lowest probability of going out of business, becoming inactive or filing for bankruptcy, and nine (9) represents businesses with the highest probability. As an example, using this expanded definition of an active business, we can predict business closing for small businesses that may slowly reduce their activity over time until they eventually cease to exist.

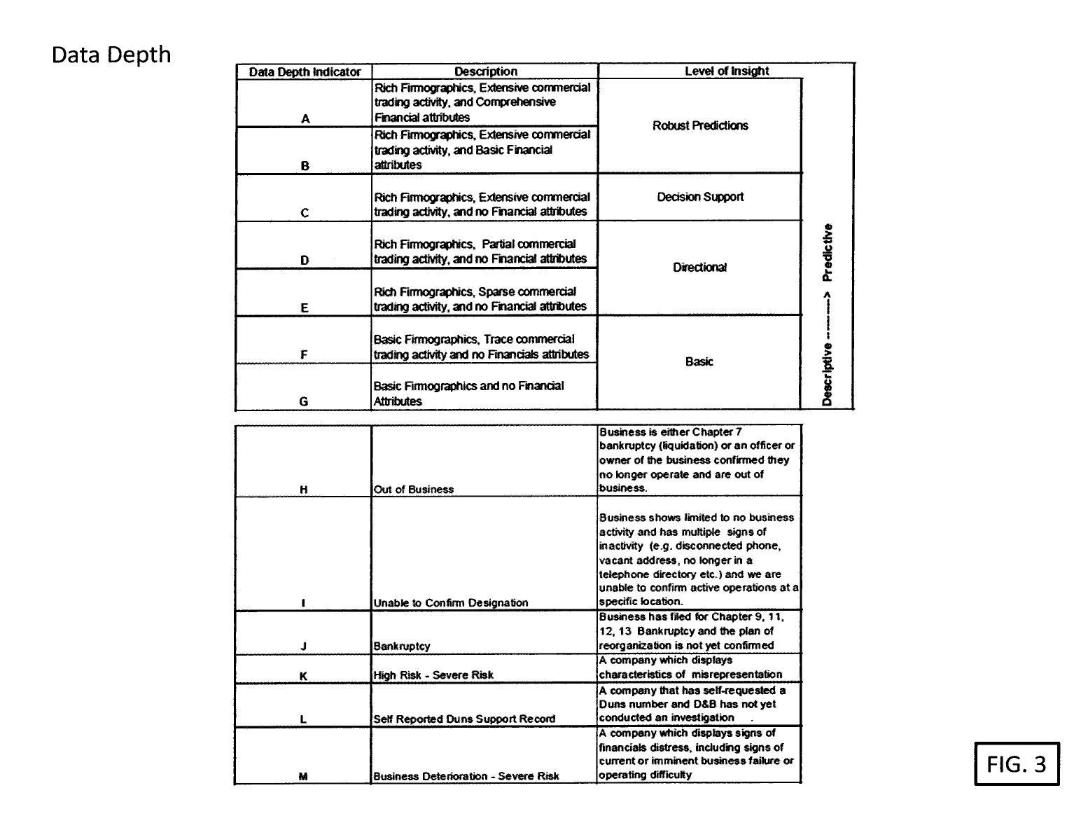

A data depth indicator provides insights into the level of predictive data elements available on a business. It allows users to understand and have confidence in the underlying data inputs used to assess viability. Refer to FIG. 3 for the key to an exemplary data depth indicator.

An exemplary of a company profile category is in the range from A-Z based on a combination of the following characteristics like number of years in business, number of employees or annual sales volumes and volume of payment transactions. i.e.:
Young: Less than 5 years in business
Established: More than 5 years in business
Small: Less than 10 employees or missing actual employees, or less than $100,000 in annual sales or missing actual sales
Medium: Between 10-49 employees or between $100,001-$499,999 in annual sales
Large: Greater than 50 employees or greater than $500,000 in annual sales
Financial Statement available or not available
Three (3) or more trade payment references available

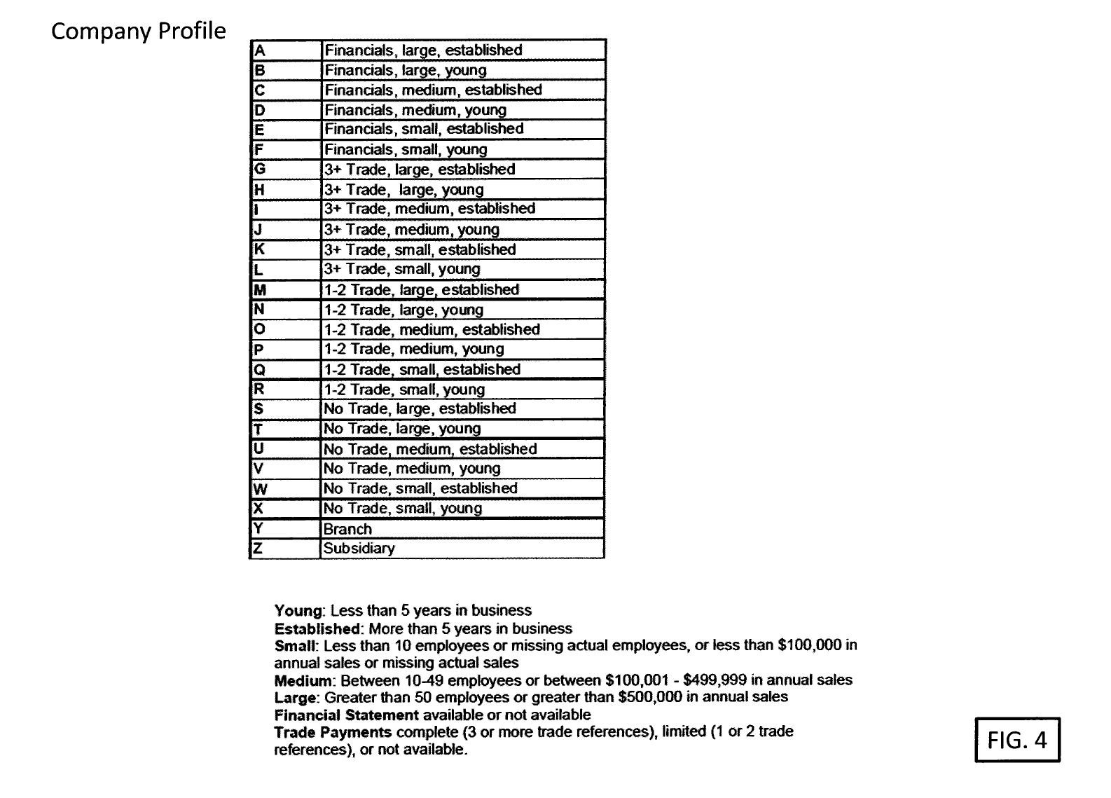

A company with an A profile is the largest, most established businesses with complete financial statement and trade payment data. A company B with an X profile is the smallest, youngest businesses with no financial or trade payment data available. Refer to FIG. 4, Appendix B, for exemplary company profile categories.

### Model Development

The predictive components of a viability rating were based on statistical modeling techniques to select and weight the data elements that are most predictive of business closure, inactivity and bankruptcy, and related aspects of business behaviors. The resulting models are mathematical equations that consist of a series of variables and coefficients (weights) that have been calculated for each variable. One technique that predictive model are based on if the logistic regression technique which an established best practice way of building models with binary dependent variable.

Extensive data analysis was conducted to determine those variables that are statistically the most significant factors for predicting closure, inactivity and bankruptcy and calculate the appropriate weights for each. Hundreds of predictive variables were identified by evaluating a combination of both “good” and “bad” performing businesses in the database.

The present disclosure makes use of activity signal data (ADS) generated by a rules-driven, data collection and maintenance system of data sources. The ADS is particularly beneficial to differentiate between low and high risk on small businesses that tend to have limited or no commercial trade history. We have also enhanced the depth of data utilized by the scores through the use of detailed transactional payment data on businesses with established commercial trade history. Detailed trade uses granular payment data and captures month-to-month fluctuations in payment behavior, and provides predictive lift to the scores.

### Scoring System and Model Generation for a Viability Rating

The ability to accurately assess risk is dependent on the availability of robust underlying data elements, so we have developed a scoring system that accounts for the correlation between depth of predictive data and future viability.

The exemplary result is a suite of models consisting of four unique scorecards, with each scorecard driven by depth of predictive data elements, such as business identity data including business size and industry, commercial payment transactions including total dollars owed 3 months ago, financial data attributes available on a business like the current ratio, etc.

A viability score provides, as an example, a 1-9 ranking based on all four models combined. A portfolio comparison provides, as an example, a 1-9 ranking based on the individual model segment. Providing both views allows of a better understanding of risk relative to the full universe of businesses and relative to just those businesses within the same model segment. Having a system of models allows for better separation of “goods” and “bads” by focusing on unique populations. It also provides for the most predictive score possible, optimized on the data available.

A viability rating, therefore, provides maximum risk discriminatory power with segmented scorecards for improved risk management decisions.

Table 1 below, provides the projected “bad” rate (e.g., Out of Business rate) based on out-of-time samples.

TABLE 1
PROJECTED OUT OF BUSINESS
RATE BY VIABILITY SCORE

| | | Out of Business (Bad) |
|---|---|---|
| Viability Score | Percent of Total | Rate |
| 9 | 1% | 65% |
| 8 | 8% | 42% |
| 7 | 14% | 27% |
| 6 | 30% | 13% |
| 5 | 14% | 7% |
| 4 | 14% | 5% |
| 3 | 15% | 3% |
| 2 | 4% | 2% |
| 1 | 0.3% | 0.2% |

Each viability score has a “bad” rate that can be compared with the average. For example, Table 1 above shows that 1% of all companies scored a 9 and of that group, 65% are projected to go out of business, become inactive, or file for bankruptcy over the next 12 months. What this means is that businesses with a viability score of 9 are approximately 5 times (65/14=5) more likely to go bad than the average and 325 times (65/0.2=325) more likely to go bad than the businesses with a viability score of 1.

A data depth indicator component captures the power of information that one has about the company and is used in order to create the viability score. Power of a viability piece can be measures in terms of model accuracy and separation. But there are many instances in risk modeling where the model can have a good accuracy, but it is not performing well in identifying the good account versus bad account. In order to be successful in risk analytics, distinguishing between good and bad accounts is very important. Thus, a data depth indicator or score based on this particular aspect of modeling is also used in generating a viability rating. There are many standard well defined statistics like Kolmogorov-Smirnoff, Gini Index, Divergence, ROC etc., that captures the separation power of a multivariate statistical model. The present inventors have combined all those statistics in one indicator or score using a principal component analysis approach. These scores are finally used in creating a weight for each dimensions of a company that are used in calculating the viability score.

Weighting Strategy for Regression with Multiple Dependent Variables

When multiple binary dependent variables are combined into one dependent variable using an “or” condition for example Overall bad=bad1 or bad2 or bad3. The bad definition with the highest bad rate will dominate and overshadow the others. In this application, the bad rate 1=0.22%, bad rate 2=0.32% and bad rate 3=0.12%. Without a weight regression model it will be more accurate for bad 2 but less so for either bad 1 or bad 3.

### Methodology:

To ensure that the regression model would work well on all three bad definitions the weighted bad rates and the number of weighted bads would be set so that for each of the three bad definitions that would be equal in terms of counts and rates. A final set of weights was created to ensure that the overall count and bad rates would be the same as the original dataset to ensure proper intercept value and P statistics against an unweighted sample. Shown below is a series of tables that give the actual counts and weights used in the weighting scheme.

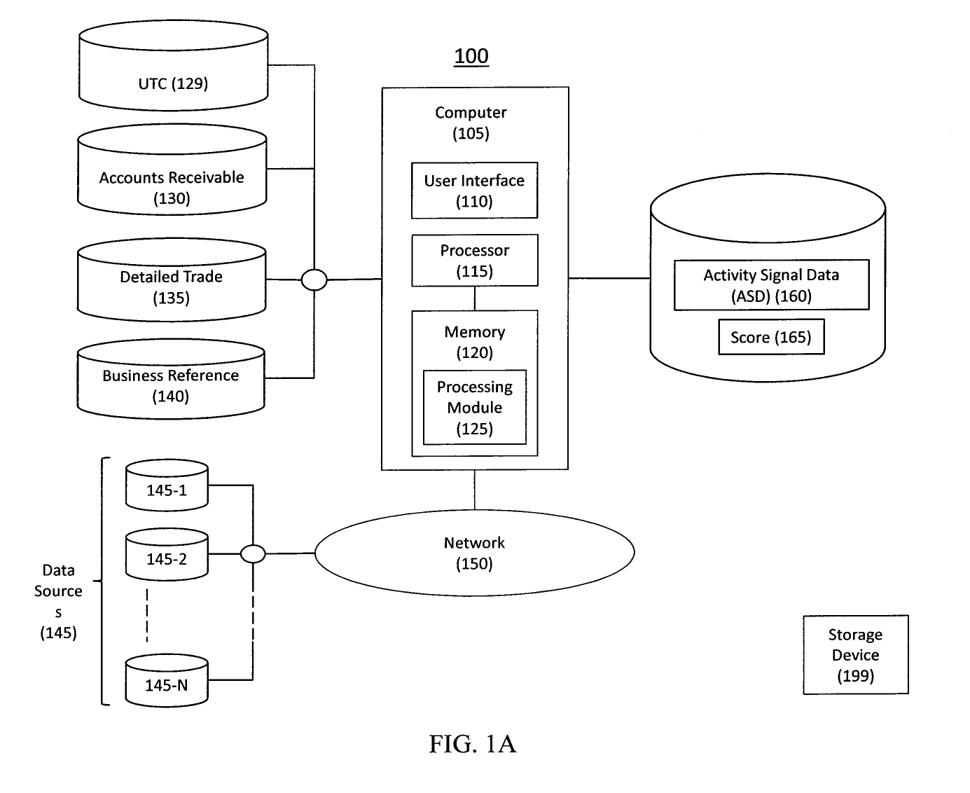

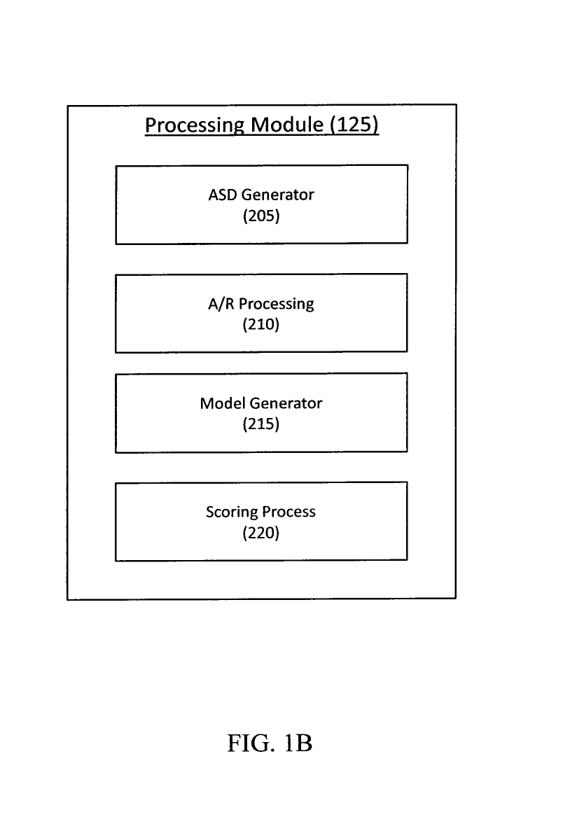

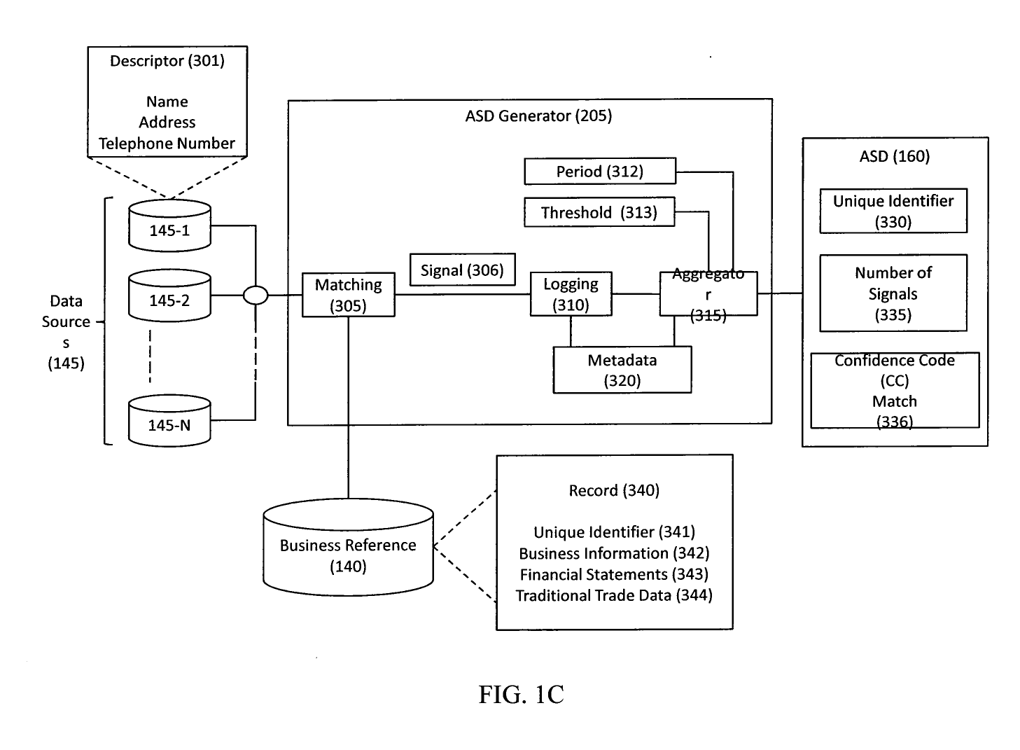

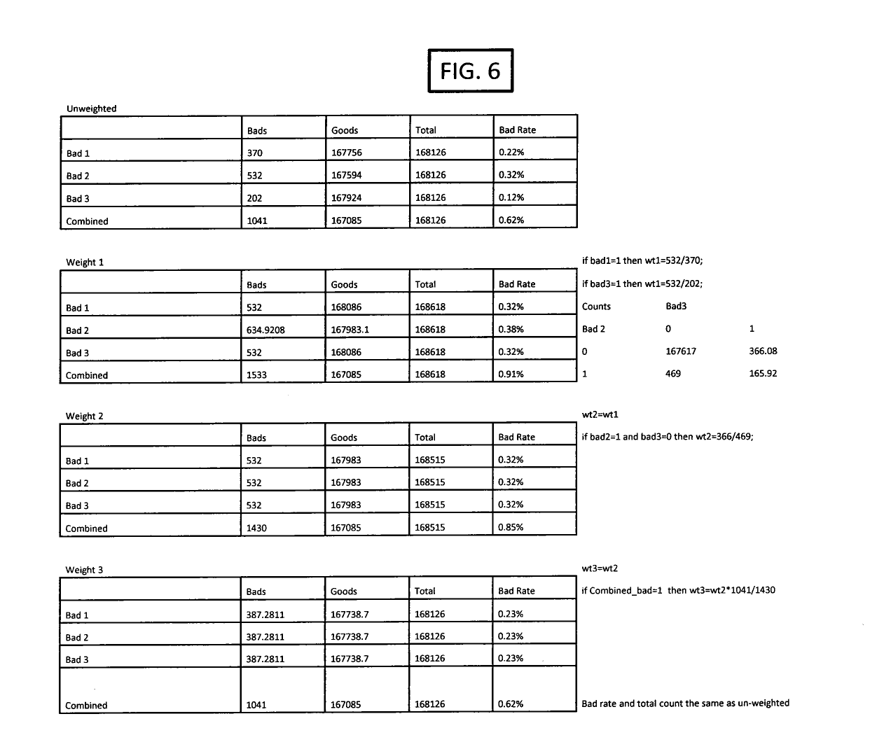

The first step was to increase the weighted bad count of bad 1 and bad 3 up to the count of bad 2. Bad 1 is mutually exclusive of bad 2 and bad 3 but there is an overlap between bad 2 and bad 3. Due to the possibility of an account being both bad 2 and bad 3, a second weight had to be applied that would weight down accounts that were bad 2 but not bad 3. Finally, a third weight was applied to bring the overall bad rate and count back to the original unweighted dataset (see FIG. 6). FIG. 1A is a block diagram of a system 100, for employment of the techniques disclosed herein. System 100 includes (a) a computer 105, (b) data sources 145-1, and 145-2 through 145-N, collectively referred to as data sources 145, which are communicatively coupled to computer 105 via a network 150.

Network 150 is a data communications network. Network 150 may be a private network or a public network, and may include any are all of (a) a personal area network, e.g., covering a room, (b) a local area network, e.g., covering a building, (c) a campus area network, e.g., covering a campus, (d) a metropolitan area network, e.g., covering a city, (e) a wide area network, e.g., covering an area that links across metropolitan, regional, or national boundaries, or (f) the Internet. Communications are conducted via network 150 by way of electronic signals and optical signals.

Each of data sources 145 is an entity, organization, or process that provides information, i.e., data, about a business. Examples of data sources 145 include business registries, phone books, accounts receivables invoice-level payment data, and business inquiries about other businesses.

Computer 105 processes data from data sources 145, and also processes data that is designated herein as UTC data 129, accounts receivable data 130, detailed trade data 135 and business reference data 140, and produces data designated as activity signal data (ASD) 160 and a score 165.

Accounts receivable data 130 is accounts receivable data that has been obtained from a plurality of businesses that have supplied goods or services to other businesses, or credit. Accounts receivable data 130 about a company of interest is obtained from suppliers of goods or services to the company of interest. For example, assume that Company B is a supplier of goods or services to Company A. Company B, on its books, would show an accounts receivable amount due from Company A. In practice, there would likely be many companies that supply goods or services to Company A, and as such, accounts receivable data for Company A would include the accounts receivable data about Company A from those many companies.

Detailed trade data 135 is other data about a company of interest, and may be derived from accounts receivable data 130. Examples of detailed trade data 135 include number of accounts past due in last six months, and total amount owing.

Business reference data 140 is data that describes a business. For example, for a subject business, business reference data 140 will include a unique identifier of the subject business, business information, financial statements, and traditional trade data. The unique identifier is an identifier that uniquely identifies the subject business. A data universal numbering system (DUNS) number can serve as such a unique identifier. Business information is information about a business such as, number of employees, years in business, and an industry, e.g., retail, within which the business is categorized. Financial statements are financial information such as quick ratios, i.e., (current assets-inventory)/current liabilities, and total amount of liabilities. Traditional trade data is information such as amount thirty days or more past due, number of payment experiences thirty days or more past due, and number of satisfactory payment experiences.

ASD 160 is information about companies derived from data obtained from data sources 145. In general, with regard to a subject company, ASD 160 indicates a level of processing activity, by other companies, concerning the subject company.

Score 165 is a viability rating.

Detailed trade data 135, business reference data 140, ASD 160 and score 165 are stored in one or more databases. The one or more databases can be configured as a single storage device, or as a distributed storage system having a plurality of independent storage devices. Although in system 100 the one or more databases are shown as being directly coupled to computer 105, they can be located remotely from, and coupled to, computer 105 by way of network 150.

Computer 105 includes a user interface 110, a processor 115, and a memory 120 coupled to processor 115. Although computer 105 is represented herein as a standalone device, it is not limited to such, but instead can be coupled to other devices (not shown) in a distributed processing system. User interface 110 includes an input device, such as a keyboard or speech recognition subsystem, for enabling a user to communicate information and command selections to processor 115.

User interface 110 also includes an output device such as a display or a printer, or a speech synthesizer. A cursor control such as a mouse, track-ball, or joy stick, allows the user to manipulate a cursor on the display for communicating additional information and command selections to processor 115.

Processor 115 is an electronic device configured of logic circuitry that responds to and executes instructions.

Memory 120 is a tangible computer-readable storage device encoded with a computer program. In this regard, memory 120 stores data and instructions, i.e., program code, that are readable and executable by processor 115 for controlling operations of processor 115. Memory 120 may be implemented in a random access memory (RAM), a hard drive, a read only memory (ROM), or a combination thereof. One of the components of memory 120 is a processing module 125.

Processing module 125 is a module of instructions that are readable by processor 115, and that control processor 115 to perform a scoring of a business, i.e. evaluation of the business by an assignment of a probability of delinquency which is converted to a delinquency score, i.e., score 165. Processing module 125 outputs results to user interface 110 and can also direct output to a remote device (not shown) via network 150.

In the present document we describe operations being performed by processing module 125 or its subordinate processes. However, the operations are actually being performed by computer 105, and more specifically, processor 115.

The term “module” is used herein to denote a functional operation that may be embodied either as a stand-alone component or as an integrated configuration of a plurality of subordinate components. Thus, processing module 125 may be implemented as a single module or as a plurality of modules that operate in cooperation with one another. Moreover, although processing module 125 is described herein as being installed in memory 120, and therefore being implemented in software, it could be implemented in any of hardware (e.g., electronic circuitry), firmware, software, or a combination thereof.

While processing module 125 is indicated as already loaded into memory 120, it may be configured on a storage device 199 for subsequent loading into memory 120. Storage device 199 is a tangible computer-readable storage medium that stores processing module 125 thereon. Examples of storage device 199 include a compact disk, a magnetic tape, a read only memory, an optical storage media, a hard drive or a memory unit consisting of multiple parallel hard drives, and a universal serial bus (USB) flash drive. Alternatively, storage device 199 can be a random access memory, or other type of electronic storage device, located on a remote storage system and coupled to computer 105 via network 150.

In practice, data sources 145, accounts receivable data 130, detailed trade data 135 and business reference data 140 will contain data representing many, e.g., millions of, data items. Thus, in practice, the data cannot be processed by a human being, but instead, would require a computer such as computer 105.

FIG. 1B is a block diagram of processing module 125. Processing module 125 includes several subordinate modules, namely, an activity signal data (ASD) generator 205, accounts receivable (A/R) processing 210, a model generator 215, and a scoring process 220. In brief:
(a) ASD generator 205 analyzes data from data sources 145, and produces ASD 160, which, as mentioned above, with regard to a subject company, indicates a level of processing activity, by other companies, concerning the subject company;
(b) A/R processing 210 analyzes accounts receivable data 130 from suppliers of a subject businesses, and produces weights that are indicative of whether the subject businesses are in good standing with regard to their payments of debts, or delinquent on their payments of debits;
(c) model generator 215 processes various business data, ASD 160 and the weights from A/R processing 210, and based thereon, generates a model for scoring a business; and
(d) scoring process 220 utilizes the model from model generator 215 to produce score 165.

Each of ASD generator 205, A/R processing 210, model generator 215, and scoring process 220 is described in further detail below.

FIG. 1C is a block diagram of ASD generator 205, which, as mentioned above, analyzes data from data sources 145, and produces ASD 160. ASD generator 205 includes a matching process 305, a logging process 310, and an aggregator 315.

Data sources 145, as mentioned above, are entities, organizations, or processes that provide information, i.e., data, about a business. The format of the data is not particularly relevant to the operation of system 100, but for purposes example, we will assume that the data is organized into records. A descriptor 301 is an example of such a record, and contains data that describes various aspects of a business, for example, name, address and telephone number. In practice, descriptor 301 can include many such aspects.

Matching process 305 receives, or otherwise obtains, from data sources 145, descriptor 301, and matches descriptor 301 to data in business reference data 140.

Business reference data 140, as mentioned above, is data that describes a business. Business reference data 140 is organized into records. One such record, i.e., a record 340, is a representative example. Record 340 includes a unique identifier 341, business information 342, financial statements 343, and traditional trade data 344.

Matching, as used herein, means searching a data storage device for data, e.g., searching a database for a record, that best matches a given inquiry. Thus, matching process 305 searches business reference data 140 for data that best matches descriptor 301.

A best match is not necessarily a correct match, and so, matching process 305, upon finding a match, also provides a confidence code that indicates a level of confidence of the match being correct. For example, a confidence code of 5 may indicated that the match is almost definitely correct, and a confidence code of 1 may indicate that the match has a relatively low certainty of being correct.

Matching process 305, upon finding a match, produces a signal 306, which includes:
(a) identification of source from which data was received;
(b) a time (which includes a date) at which the match was made;
(c) unique identifier 341; and
(d) the confidence code.

Logging process 310 receives signal 306, and enters it into a log, designated herein as metadata 320. Table 2 lists some exemplary metadata 320.

TABLE 2
Exemplary Metadata 320

| | | | Unique | |
|---|---|---|---|---|
| Signal | Source | Time | Identifier | Confidence Code |
| 1 | 145-2 | t0 | 00000001 | 2 |
| 2 | 145-1 | t1 | 00000002 | 1 |
| 3 | 145-1 | t2 | 00000001 | 3 |
| 4 | 145-1 | t3 | 00000001 | 3 |
| . | . | . | . | . |
| . | . | . | . | . |
| . | . | . | . | . |

For example, Table 2, row 1, shows that matching process 305 produced a first signal, i.e., signal 1, that indicates that matching process 305, at time t0, matched a descriptor 301 from data source 145-2 to data in business reference data 140. The match indicates that descriptor 301 concerns a business identified by unique identifier 00000001, and the match has a confidence code of 2. In practice, metadata 320 will contain many, e.g., millions, of rows of data.

Aggregator 315 aggregates data from metadata 320 to produce ASD 160. More specifically, aggregator 315 considers metadata 320 that falls within a period of time, i.e., a period 312, and, for each unique identifier maintains a total number of signals, and a total number of matches having a confidence code greater than or equal to a threshold 313. Thus, for a subject business, ASD 160 includes, a unique identifier 330, a number of signals 335, and a confidence code (CC) match 336. Number of signals 335 is the total number of signals for a particular unique identifier that were matched during period 312. CC match 336 is the total number of those matches having a confidence code greater than or equal to threshold 313.]

For example, referring to Table 2, assume that period 312 defines a period of time from t0 through t4, and that threshold 313 defines a threshold value of 3. Table 3 lists corresponding exemplary data for ASD 160.

TABLE 3
Exemplary Data for ASD 160

| | | Matches having |
|---|---|---|
| | | confidence code |
| Unique | Total number of | greater than or |
| Identifier (unique | signals (number of | equal to threshold |
| identifier 330) | signals 335) | (CC match 336) |
| 00000001 | 3 | 2 |
| 00000002 | 1 | 0 |

Table 3 shows that, during the period of t0 through t4, for unique identifier 00000001, there was a total of 3 signals (see Table 1, signals 1, 3 and 4), and of those 3 signals, 2 of them were for matches having a confidence code of greater than or equal to 3 (see Table 2, rows 3 and 4). Although not shown in Table 3, ASD 160 can include other information derived from signal 306, for example an identification of data sources 145 that provided data that resulted in the greatest number of matches having a confidence code greater than or equal to threshold 313. In practice, period 312 will be of a length, e.g., 12 months, that enables ASD generator 205 to gather a significant number of events. As such, ASD 160 will include many, e.g., millions, of rows of data.

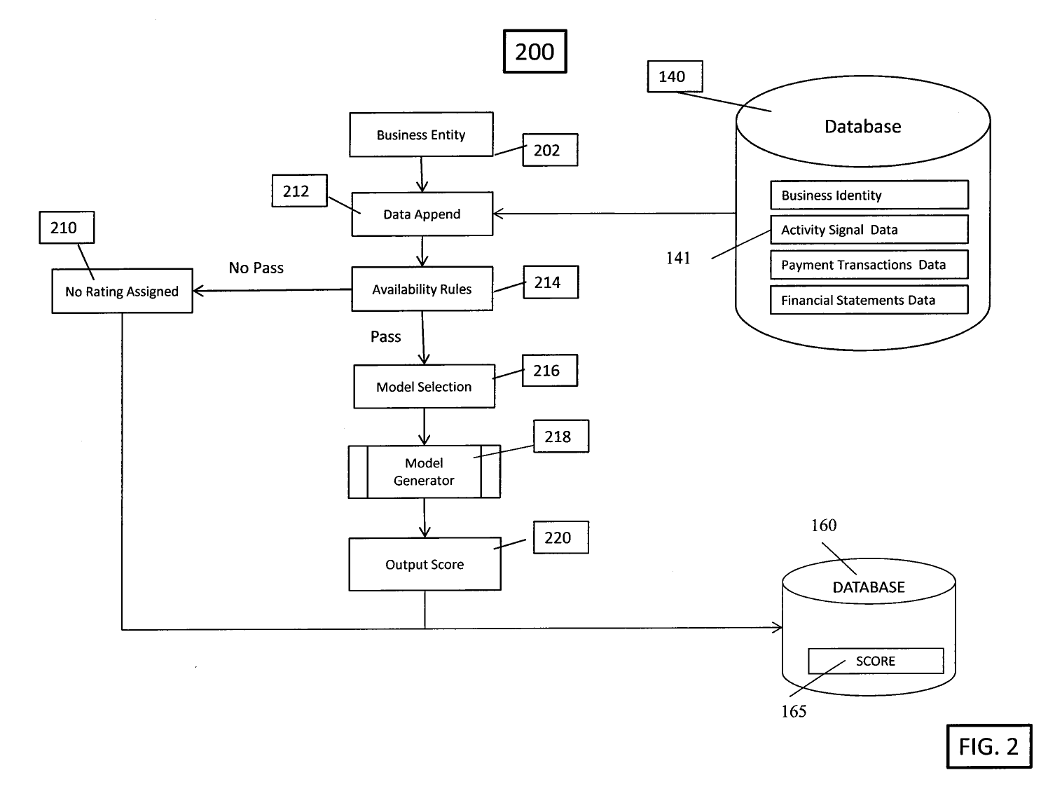

FIG. 2 is a flowchart of the scoring process for the viability rating, designated herein as a method 200. Method 200 commences with step 202.

In step 202, computer 805 receives from database 840, a company record to be scored. In step 204, companies go through the entity matching process. In step 206, matched companies go to step 208. In step 210 unmatched records will get null scores.

During step 212, data is appended to the records from all data sources listed in FIG. 1. In step 214 companies are checked for availability and exclusion rules.

In step 216, data is recoded based on the record and evaluated for model selection. Model selection is dependent on availability of data and its depth. For example, record will go through the FN segment if it has sufficient information from the financial statements. If the record has no visible trade activity, it would go through the NT segment and be evaluated only based on firmographics, intelligence engine signals or other available data.

In step 218, record will go through assignment of points based on value of the predictors from each data source. Predictor selection is based on which segment the records qualified for.

During the scoring process, step 220, points for the record are summed up for the score and data depth dimensions. Record is scored for the first three components.

Next, in step 222, company goes through a set of queries to check for business adjustments that include, but are not limited to, special categories, for example, high risk case or out of business. Rating is adjusted based on the special categories that the company was classified with. There is a priority built into the adjustment rules to focus on the overall impact of known information on the viability.

Based on the results from step 222, final scoring and assignment of all components of the rating is conducted in step 224. If the company didn't qualify for any adjustments, it carries over same scores as in step 220. If the company qualified for adjustments to the score, it carries over the scores from step 222. The demographical component of the rating is defined during the final scoring module, step 224.

FIG. 3 is a description of the data depth component of the viability rating.

FIG. 4 is a description of the company profile component of viability rating.

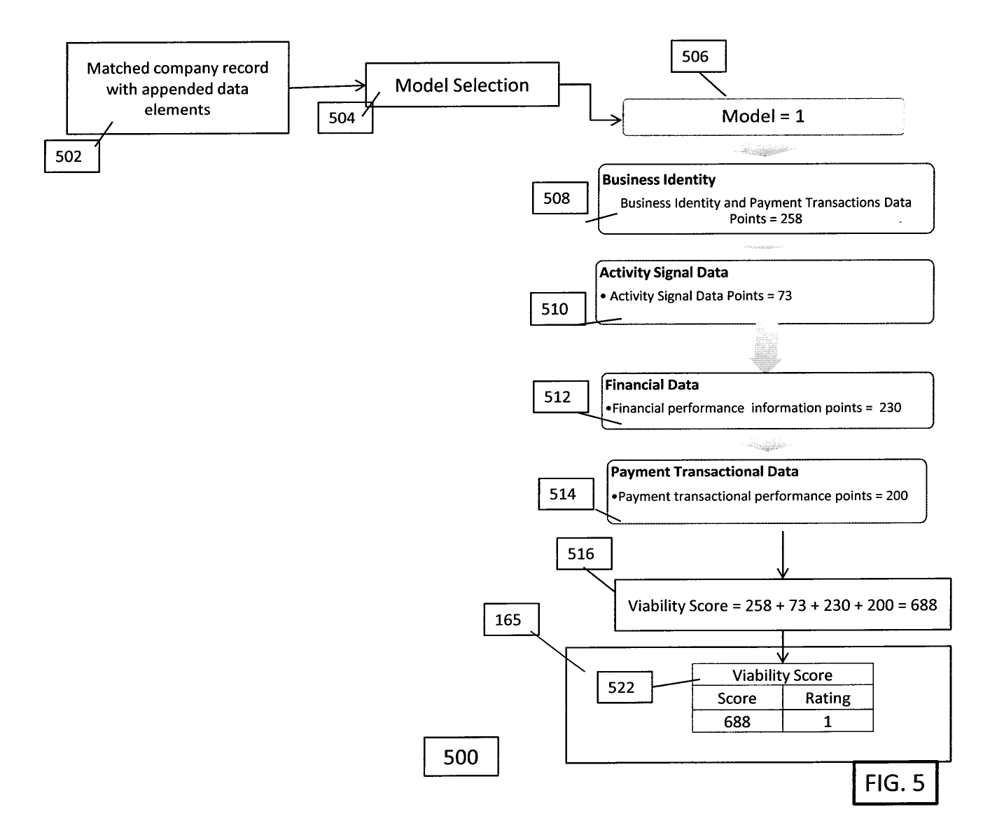

FIG. 5 is a description of the manner in which the four components of the scorecard are used to produce the viability rating. A corporate identity record is selected for scoring at module 502. Data elements have been appended to the record. During the process in step 504, model selection, the record goes through a series of queries to determine which model segment it should go through. In this particular case, company has data from financial statements which qualifies it to go through the FN model (step 506). Viability and data depth points from each data source are summed up from steps 508-514, thereby generating a viability score 516 and a data depth score 518.

In step 520, the Demographical Segment is assigned. In viability segment 522, the viability score and portfolio comparison are calculated based on the score points from viability score 516. Mapping of the score points to the rating value is conducted during the step 522 for both viability components. In 524, points for the data depth are mapped to the data depth rating. In step 526 records are adjusted based on the special categories, which may include, but are not limited to, the out of business or high risk case. In this example, record doesn't qualify for any adjustments and advances to step 528. In step 528, final viability rating is presented or outputted to the user. Record projects same scores as in steps 520, 522 and 524, respectively.

FIG. 6 shows the value of the first component—viability score. Rating scale 1-9 is presented here as an example. Cut offs by each class were determined by the bad rate. The higher the value of the rating, the more risky the business is. Users will try to avoid ‘bad’ businesses. Businesses that are not likely to be viable and at the same time not end up avoiding good businesses. In the example shown, overall bad rate is 19.9%. A business not utilizing this solution will simply end up with 19.9% bad rate in their portfolio. By using the methodology of the present disclosure, users can avoid segments 9 and 8 with much higher bad rates and evade doing business with records from more risky segments.

The use cases for the viability rating of the present disclosure are numerous —ranging from risk assessment to supply chain analytics to marketing uses for prescreening or improved targeting.

As one example, a large bank trying to expand their loan portfolio. Using the viability rating of the present disclosure, the bank discovered that this viability rating identified segments with response rates four (4) times higher than conventional rating systems.

While we have shown and described several embodiments in accordance with our disclosure, it is to be clearly understood that the same may be susceptible to numerous changes apparent to one skilled in the art. Therefore, we do not wish to be limited to the details shown and described but intend to show all changes and modifications that come within the scope of the appended claims.

What is claimed is:

1. A method for determining an entity's future commercial viability, said method comprising:
(a) using a first predictive modeling, determining a future commercial viability of the entity, said first predictive modeling is derived by identifying patterns in data and relating to predictive attributes, thereby generating a viability score;
(b) using a second predictive modeling to generate a relative ranking of the entity against its peer group, thereby generating a comparative viability score;
(c) measuring data depth to quantify how much is known about the entity and how much confidence is had in the viability score and the comparative viability score, thereby generating a data depth indicator;
(d) assigning a company profile by segmentation to define and group the entity with other similar entities; and
(e) outputting a multi-dimensional viability rating comprising the viability score, the comparative viability score, the data depth indicator, and the company profile.

2. The method of claim 1, wherein said company profile defines and groups said entity with other similar entities in terms of at least one selected from the group consisting of: size, years in business, availability of complete financial statement and commercial trade history.

3. The method of claim 1, wherein said viability score is predictive rating on a viability score scale.

4. The method of claim 3, wherein said viability score scale is in the range between about 1 to about 9, wherein 1 is the lowest probability of an entity going out of business or becoming inactive over a period of time compared to other businesses, and 9 is highest probability of going out of business or becoming inactive.

5. The method of claim 1, wherein said comparative viability score is predictive rating on a comparative viability score scale.

6. The method of claim 5, wherein said comparative viability score scale is in the range between about 1 to about 9, where 1 is the lowest probability of going out of business or becoming inactive over a period of time compared to other businesses within the same model segment, and 9 is the highest probability of going out of business or becoming inactive.

7. The method of claim 1, wherein said data depth indicator is a descriptive rating based on a data depth indicator scale.

8. The method of claim 7, wherein said data depth indicator scale is in the range between about A-M.

9. The method of claim 8, wherein said A-G is assigned on a “report card-like” scale, where A is assigned to businesses with the highest level of predictive data selected from the group consisting of: complete firmographics, extensive commercial trading activity, comprehensive financial attributes and mixture thereof, and G is assigned to a business with the lowest level of predictive data.

10. The method of claim 9, wherein said predictive data is basic identity data.

11. The method of claim 8, wherein said H-M are special categories that override the A-G rating giving users further insight when confirmation that a business has met one of a predefined set of risk conditions.

12. The method of claim 1, wherein said company profile is a descriptive rating based on a company profile scale.

13. The method of claim 12, wherein said company profile scale is in the range between about A-Z.

14. The method of claim 13, wherein A is the largest, most established businesses with complete, comprehensive data reported and X is the smallest, youngest business with basic business identity data.

15. A computer readable storage media containing executable computer program instructions which when executed cause a processing system to perform a method for determining an entity's future commercial viability, said method comprising:
(a) using a first predictive modeling, determining a future commercial viability of the entity, said first predictive modeling is derived by identifying patterns in data and relating to predictive attributes, thereby generating a viability score;
(b) using a second predictive modeling to generate a relative ranking of the entity against its peer group, thereby generating a comparative viability score;
(c) measuring data depth to quantify how much is known about the entity and how much confidence is had in the viability score and the comparative viability score, thereby generating a data depth indicator;
(d) assigning a company profile by segmentation to define and group the entity with other similar entities; and
(e) outputting a multi-dimensional viability rating comprising the viability score, the comparative viability score, the data depth indicator, and the company profile.

16. A computer system for determining an entity's future commercial viability, said system comprising:
a database comprising activity signal data;
an activity signal generator which aggregates said activity signal data using a plurality of data sources from multiple of businesses that are in business with an entity of interest; and
a model generator which generates a viability score based upon a statistical model in which a dependent variable performance is derived using statistical probability from independent variables created from a plurality of data sources.

17. The system according to claim 16, wherein said processor which execute the following steps stored in memory; said steps comprising:
(a) using a first predictive modeling, determining a future commercial viability of the entity, said first predictive modeling is derived by identifying patterns in data and relating to predictive attributes, thereby generating a viability score;
(b) using a second predictive modeling to generate a relative ranking of the entity against its peer group, thereby generating a comparative viability score;
(c) measuring data depth to quantify how much is known about the entity and how much confidence is had in the viability score and the comparative viability score, thereby generating a data depth indicator;
(d) assigning a company profile by segmentation to define and group the entity with other similar entities; and
(e) outputting a multi-dimensional viability rating comprising the viability score, the comparative viability score, the data depth indicator, and the company profile.

18. The system according to claim 16, wherein said activity signal generator comprises:
a matching process which upon finding a match produces a signal;
a logging process which receives said signal, and enters it into metadata; and
an aggregator which aggregates data from said metadata, thereby producing said activity signal data.

19. The system according to claim 18, wherein said signal comprises at least one selected from the group consisting of:
identification of source from which data was received;
a time at which the match was made;
unique identifier 341; and
a confidence code.
